(19) United States
(12) Patent Application Publication
(10) Pub. No.: US 2021/0025372 A1
(43) Pub. Date: Jan. 28, 2021

(54) MESHOD AND DEVICE TO PRODUCE ALTERNATIVE ENERGY BASED ON STRONG COMPRESSION OF ATMOSPHERIC AIR

(71) Applicant: GENNADY SERGEEVICH DUBOVITSKIY, GELENDZHIK (RU)

(72) Inventor: GENNADY SERGEEVICH DUBOVITSKIY, GELENDZHIK (RU)

(21) Appl. No.: 16/519,268

(22) Filed: Jul. 23, 2019

(51) Int. Cl. F03G 7/04; F01K 25/10; F01K 13/00

(52) U.S. Cl. CPC F03G 7/04; F02C 1/05; F01K 13/00; F01K 25/10

(57) ABSTRACT

Alternative energetics based on the extraction of internal thermal energy in the process of high compressing of atmospheric air represents a new direction of carbon-free energetics. As a result of strong isothermal compression of atmospheric air, with a removal of heat to a heater (32) and then adiabatic expansion of the compressed air, with delivery of the low-cooled air to the refrigerator (26), two of thermal sources are formed—heat-positive source and heat-negative source, which are used, respectively, for heating and a condensation of a low-boiling point working fluid (refrigerant). The technology of separate removal of moisture condensate and engine oil in the process of compressing atmospheric air is provided. Heat exchanger (25) reduces heat and cold losses and, thus, significantly increases the production of alternative energy. Heat-engine (30) operating on the low-boiling point working fluid coupled to a generator (31) to produce electrical energy. Additionally, in the process of generating of alternative energy a device can also produce—heat, cold, compressed air and distilled water.

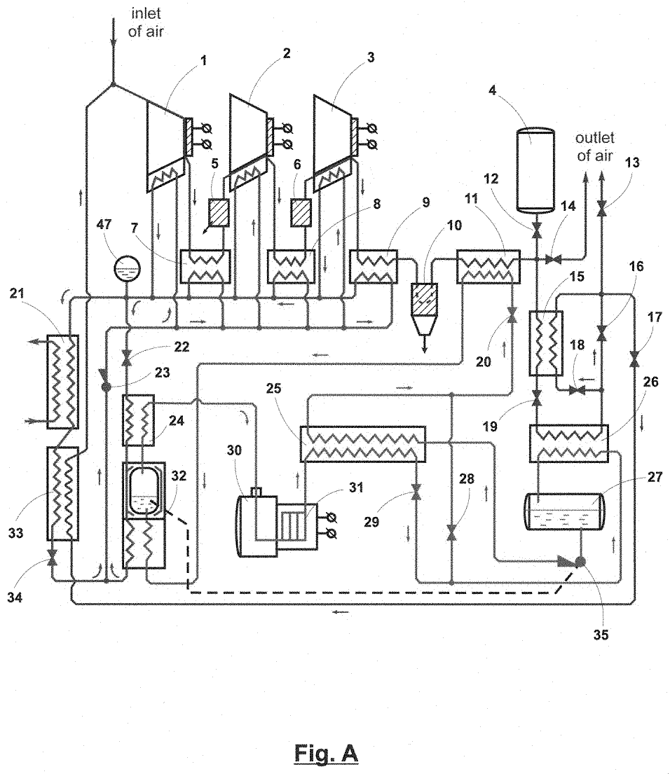

### CROSS-REFERENCE TO RELATED APPLICATION

This application climes the benefit of provisional patent application Ser. No 62/711,489, filed 2018 Jul. 28 by the present inventor.

### BACKGROUND—PRIOR ART

The method for extracting energy from highly compressed atmospheric air is related to pure carbon-free alternative energetics that helps withstand climate change and reduces dependence on fossil fuels.

The First Law of Thermodynamics (the Law on Conservation of Energy) states that any physical body has internal energy (U), which can be increased in two ways—heating a body (Q), or to doing work on it (A): ΔU=Q+A. The converse statement is also true: if a body produces a work or loses its own heat, its internal energy is reduced by an amount A or Q.

Atmospheric air, consisting of a mixture of two superheated gases, nitrogen and oxygen, contains an unlimited amount of internal energy, constantly coming from the Sun. Also, modern energetics, based on the combustion of hydrocarbon fuel, releases into the environment a huge amount of heat, due to the low efficiency of heat engines. Carbon dioxide as a product of combustion enters the atmosphere and creates a greenhouse effect that retains heat and contributes to an increase in its temperature. Thus, we have the unlimited heat source that can be used both for generating electrical energy and for other useful purposes.

It is known that one cubic meter of air, heated to T=27° C. (300° K) at P=1 bar, contains about 10,000 kJ of heat, or about 3 kWh of thermal energy. Calculations show that the extraction of 1÷1.5 kWh of thermal energy from 1 cubic meter of air is completely solvable and efficient, since the work expended on the concentration of its internal energy (compression) is 10÷11 times less than the energy that can be received.

Air temperature, after extraction of internal energy from it, significantly decreases to −160°÷−170° C. This low cooled air is used as a cooler for a heat engine. After which the exhaust air is discharged back into the environment, where it mixes with atmospheric air, warms up quickly and is ready for use again.

The units and technological cycles that are used in the device are practically all produced by industry and tested in practice, so the creation of a new autonomous source of renewable energy is not a problem.

To assess the efficiency of heat engine cycles (direct Carnot cycle), the thermal efficiency coefficient (η) is used—the ratio of the amount of work received (A) to the amount of heat expended (Q). η=A/Q<1

The Carnot reverse cycle, in which work is expended to generate heat or cold, has two variants of using:

a) the heat pump cycle, which takes into account heat, for example, entering a heated room, and the resulting cold is dissipated into the environment, and,

b) the refrigeration cycle, in which the cold is already taken into account, for example, obtained in refrigeration units, and the heat that is removed from the cooled products is not taken into account and is dispersed into the environment.

The cooling coefficient and the coefficient of heat use are determined by the formulas K_{hol.}=T₂/(T₁−T₂), and K_{tep.}=T₁/(T₁−T₂), where T₁ and T₂—the temperature of the hot and cold body. In this case, the refrigeration coefficient and the coefficient of heat use of the reverse Carnot cycle will be greater than 1. (K_{hol.}>1; K_{tep.}>1).

The principle of operation of the device is to concentrate low-grade heat with the help of a high-pressure compressor and increase the heat flow density and, thereby, raise the coefficient of the heat pump cycle (K_{tep.}) to 6.5.

In the proposed device, two working agents are used; one of them is air, which emits heat when it is compressed in a heat-pumping cycle, with energy expenditure.

The second working fluid is Freon, which performs work in a heat engine (direct Carnot cycle), using the temperature difference between two heat sources, hot (heat pumping cycle) and cold (cooling cycle). These two cycles are interconnected and exchange thermal energy through the heat-removing fluid in the heater (32), in the regenerative heat exchanger (11) and in the refrigerator (26). Such a relationship increases the coefficient of heat use (K_{tep.}) for the Carnot reverse cycle (air), up to 10÷11, that allows to use part of the energy received (about 10%) to operate the high-pressure compressor.

The efficiency of the direct (Freon) cycle is not a constant value and varies depending on the operating conditions of the device (η=0.4÷0.7).

To determine the optimal air pressure, for concentrating its internal energy, refer to the graph (Fig. F). From the graph it can be seen that the line of fracture passes at the point of 200 bars, where the steep falling graph becomes flatter one. This means that the heat capacity of the compressed gas increases at this point, and therefore much more a heat can be extracted from compressed air at a pressure of about 200 bars and more, than at low pressure.

In addition, to achieve high air pressure, a multi-stage process of isothermal compression is applied (air cooling to the initial temperature), with heat removal from each stage. In this case, the total work expended on the operation of the compressor in each stage will be significantly lower (i.e. more efficiently) compared to single-stage compression.

There is a similar patent application # PCT/IN2012/000648 (2011) “Atmospheric energy tapping device for generation of mechanical and electrical energy”. This application describes a device for extracting energy from the environment by means of compressor, in which such gases as Air, Nitrogen, Helium, Carbon dioxide, Methane, etc. are used as a compressible (working) fluid. However, there are no data on the compression process of those gases, such as—the number of compression steps, pressure and temperature. There is also no thermal calculation of this device. In addition, the operating conditions of the compressor as an adiabatic process, is not acceptable, since the absence of cooling the compressor in the presence of thermoinsulation will lead to its overheating and failure. All of the above gases (except Air) must operate in a closed system; however all devices are described as the open systems.

Patent application PCT/EA2010/000009 (Sep. 30, 2010) describes a device for converting low-potential thermal energy into mechanical and electrical energy using a low-boiling liquid phase transition (freon). From the disclosure of the invention it is known that the expansion energy of the gaseous phase of freon is converted into mechanical rotational energy using a gas turbine and an air pump, which rotates the air compressor and compresses the air. However, the performance of the gas turbine and the air pump raises doubts that there is no pressure difference between the inlet and outlet. The transition of freon to the liquid phase, after the work in gas turbine and air pump, takes place in a heat exchanger at low pressure. In order to pump the liquid freon to the high-pressure area, after the heat exchanger it is necessary to install one more pump, which must maintain a high pressure of gaseous freon before the turbine and a low pressure after the heat exchanger. Also, due to the lack of thermal calculation, this device cannot be built and tested.

The alternative source of energy based on an air compressor of high pressure was proposed by the present inventor in the patent application Aug. 26, 2012, U.S. Ser. No. 13/594,830, published Nov. 28, 2013, that has a limitation of efficiency both in the production of electricity, and in the cold. It also has low protection from refrigerants leaks and a more complex construction.

### SUMMARY

In accordance with one embodiment the method comprises an air compressor of high pressure as a concentrator of a heat of the environment and for producing a low cold, heat-exchangers for heating and condensing a low-boiling point working fluid (refrigerants), a heat-engine operating on refrigerants, coupled to an electric generator to produce electricity.

### Advantages

Accordingly several advantages of one or more aspects are as follows: to provide consumers a cheap electric energy at any time of the day and regardless of the weather conditions, that does not require a large number of storage batteries for a storage of electricity, that can have a supply of energy in the form of compressed air, that allows to use a residual cold for refrigeration and freezing chambers, and for air conditioning, that allows to use a heat for hot water supply and space heating, that allows to produce distilled water, that is compact and can be protected from a destruction by the elements.

### DRAWINGS—FIGURES

The file of this patent contains at least one color drawing. Copies of the patent with color drawings will be provided by the PTO upon payment of necessary fee.

Fig. A and Fig. B show various aspects of alternative energy device in depend of climatic zones.

Figs C, D and E visually illustrate a thermal design of the method based on a strong compression of atmospheric air.

Fig. F shows a graph of the temperature decrease at expansion of diatomic ideal gas as a function of its pressure.

Fig. G shows a cross-section one of variants of heat-engine for two cylinders operating on low-boiling point working fluid with a built-in generator.

### DRAWINGS—REFERENCE NUMERALS

1—air compressor of low pressure (first stage of compression), oil-free, having its own electric drive;
2—air compressor of average pressure (second stage of compression), oil-free, having its own electric drive;
3—air piston compressor of high pressure (third stage of compression), it's lubricated with oil, having its own electric drive;
4—high-pressure air cylinder (balloon) for stock of compressed atmospheric air;
5—air receiver with a dryer of compressed air after the first stage of compression;
6—air receiver for the second stage of compression;
7—heat-exchanger to remove a heat from compressed air after the first stage of compression using heat-removing liquid;
8—heat-exchanger to remove a heat from compressed air after the second stage of compression using heat-removing liquid;
9—heat-exchanger to remove a heat from compressed air after the third stage of compression using heat-removing liquid;
10—air cylinder for the third stage of compression with oil separator;
11—regenerative heat exchanger for overcooling of compressed atmospheric air using low-boiling point working fluid (refrigerants);
12—shut-off valve for air cylinder of high pressure;
13, 16, 17, 18—controllable air valves;
14—adjustable safety air valve;
15—heat exchanger for pre-cooling of compressed atmospheric air;
19—adjustable injector for expansion of compressed atmospheric air;
20, 28, 29, 38—valves for low-boiling point working fluid;
21—heat-exchanger to divert a heat for hot water supply or premises heating;
22, 34—valves to regulate the temperature of heat-removing liquid;
23—pump for circulation of a heat-removing liquid;
24—heat exchanger to overheat a vaporized low-boiling point working fluid;
25—heat exchanger to divide the heat flows of low-boiling point working fluid between heater and refrigerator;
26—refrigerator (heat-negative source) to cool a low-boiling point working fluid (refrigerant) to liquid phase;
27—receiver for a low-boiling point working fluid (refrigerant) in liquid phase;
30—heat-engine with a speed regulator operating on a low-boiling point working fluid;
31—reversible generator for producing of electrical energy with cooling by a low-boiling point working fluid;
32—heater (heat-positive source) with a tank to separate a vaporized working fluid;
33—heat-exchanger to regulate the temperature of a heat-removing liquid using a low-cooled atmospheric air;
35—pump for circulation of low-boiling point working fluid;
36—air radiator heat-exchanger for pre-heating of low-boiling point working fluid using heat of the environment;
37—heat-receiver for pre-heating of low-boiling point working fluid using heat of sea water, geothermal water, etc.
39—an air fan;
40—air compressor of high pressure 200 bars;
41—air radiator to dissipate a heat from compressed air into the environment;
42—kerosene burner;
43—a tank for kerosene of 1 liter;
44—calorimeter, an apparatus for measuring the amount of heat;
45—air radiator heat-receiver for pre-heating an expanded atmospheric air using heat from the environment;
46—thermoinsulation;
47—expansion tank for heat-removing liquid.

### DETAILED DESCRIPTION—FIG A—FIRST EMBODIMENT

One embodiment of the method to produce alternative energy based on strong compression of atmospheric air is illustrated in Fig. A (Scheme). In the blue color there is shown the movement of atmospheric air. Red shows the circulation of heat-removing liquid. Water or antifreeze is used as the heat-removing liquid. Green shows the circulation of low-boiling point working fluid. Refrigerants (Freons), Methane, Ethane, etc. are used as the low-boiling point working fluid in depend on climate zones.

The atmospheric air enters the device for strong compression which consists of three separate compressors (or compression stages), respectively,—low, average and high pressures. The compressor of low pressure 1 and the compressor of average pressure 2 are oil-free air compressors which are cooled using a heat-removing liquid. Also the compressor 1 has an air receiver 5 with a device for removing moisture condensate from the compressed air into the environment. The compressor of average pressure 2 also has its own air receiver 6. First air sensor and second air sensor, which are associated with the control of electric drivers of compressor 1 and compressor 2, control the predetermined air pressures, respectively, in the receiver 5 and in the receiver 6 (in scheme those air sensors are not shown).

The compressor of high pressure 3 is an oil lubricated piston compressor which cools by means of a heat-removing liquid and it has air cylinder 10 with an oil-separator. Since the compressed air entering the compressor 3 does not contain moisture condensate the oil carried away by this air into the air cylinder 10 can be returned back to the compressor 3, and it is not removed into the environment. In addition, the air cylinder 10 also has third air sensor associated with the control of electric driver of the compressor 3 to control the high pressure of air in a predetermine regime (in scheme it's not shown).

The compressor of low pressure 1 compresses the atmospheric air to 5÷7 bars. The compressor of average pressure 2 raises the pressure of air to 32÷36 bars, and compressor 3 raises the pressure of air to 200÷330 bars.

In the process of high compression of atmospheric air the concentration of its internal energy occurs and a large amount of heat is released. In addition, the energy expended on the operation of air compressors is converted into heat and added to the total flow. This heat is diverted to the heater 32 by means of a heat-removing liquid, while the high compressed air is cooled to ambient temperature.

After the oil-separator 10 the strong compressed air cleaned from moisture and oil enters the regenerative heat-exchanger 11, there it transmits its residual heat to the counter flow of liquid working fluid. Then the overcooled compressed air through the pre-cooling heat exchanger 15 enters the adjustable injector 19, where this air is expanded to atmospheric pressure and is cooled to the temperature of low cold. Further this low-cooled air is used for condensation of low-boiling point working fluid to a liquid phase in the refrigerator 26.

The pre-cooling heat exchanger 15, as well as the valves 16, 18 are designed to regulate the temperature of air in the refrigerator 26, so that the temperature of working fluid in the receiver 27 would correspond to the set value.

The adjustable injector 19 is designed to maintain a pressure of air in the compressor 3, and also to control the total volume of atmospheric air depending on the degree of the load of heat-engine 30 or generator 31.

After the refrigerator 26 the expanded atmospheric air contains a residual cold that can be used for air-conditioning of premises, refrigerating grocery chambers and to get the distilled water from ambient air, before it will be back returned to the environment. The air cylinder 4 of high pressure is designed to store the compressed atmospheric air.

The heater 32 consists of a heat exchanger and also a tank to separate the vaporized low-boiling point working fluid from its liquid phase. The tank has a sensor to maintain the set level of liquid low-boiling point working fluid with the help of the pump 35 (in scheme it's shown by a dashed line). The heat exchanger 24 serves to overheat the vaporized low-boiling point working fluid.

To control the temperature condition of the device for the production of electrical energy depending on the degree of the heat-engine 30 or generator 31 load, there are the valves 22, 26, 34 and the heat exchangers 21, 33. The heat-exchanger 21 also serves to divert a heat for domestic needs: for heating of premises and for hot water supply. The speed of circulation of heat-removing liquid in the system is regulated by the pump 23.

After the heat exchanger 24 the vaporized low-boiling point working fluid is fed to the heat-engine 30, there it does the work, cools and passes through the generator 31 to cool its. In this embodiment the heat-engine 30 and generator 31 are installed in the same housing. After the generator 31 the low-boiling point working fluid enters the heat exchanger 25 and then it is sent into the refrigerator 26 for condensation.

The heat exchanger 25 is intended to divide the counter thermal flows of low-boiling point working fluid between the heater 32 and the refrigerator 26. Thereby the heat exchanger 25 reduces the overall losses of heat and cold in the system and significantly increases the efficiency of the device for the production of electrical and heat energy.

So the residual heat, which contains the vaporized working fluid (up to condensation temperature) after heat-engine 30 and from generator 31, cannot penetrate into the refrigerator 26, because this heat will be transferred to the counter flow of cold working fluid which is sent through the regenerative heat exchanger 11 into the heater 32 for heating up. Thus, thanks to the heat exchanger 25 almost all heat entering the heater 32, ultimately, will be converted into mechanical energy in the heat-engine 30, and the losses of heat will be minimal.

On the other hand, cold, which contains the low-boiling point working fluid in the receiver 27, cannot penetrate into the heater 32 due to the heat exchanger 25, because the flow of that cold low-boiling point working fluid will transmit its cold to a warmer oncoming stream of working fluid, which directs from heat-engine 30 and generator 31 into refrigerator 26. Thus, almost all cold will be back returned in the receiver 27 herewith, the total losses of the cold will be minimal.

The first embodiment of the method and device for the production of alternative energy can work in all climatic zones.

### An Additional Embodiment—Fig. B

In a hot climate or in the presence of other thermal sources the effective power of this device for producing alternative energy can be significantly increased thanks to the additional heat. The additional heat enters the system through the air radiator heat-exchanger 36 (for blowing with hot air by fan 39) and through heat-receiver 37 for extracting of heat from sea water, geothermal water; or hot water from thermal power plants which is formed during condensation of exhaust steam after the turbine.

Since in a hot climate the amount of heat is not limited, the maximum efficiency of production of electrical energy will depend on the effective use of cold entering the refrigerator 26 with low-cooled expanded air after injector 19, on the one hand, and of cold that comes back to the receiver 27 through low-boiling point working fluid thanks to heat exchanger 25, on the other hand.

At these conditions the efficiency of the production of electrical energy of the second embodiment can be significantly increased as compared with the first embodiment.

### Operation of the Device for Production of Alternative Energy

To put into operation the device producing alternative energy, it is necessary to create a temperature difference for working fluid in the heater 32 and receiver 27. If, for example, Refrigerant-410 (R410) is used as a low-boiling point working fluid, its temperature in the heater 32 should be about +40° C., which corresponds to the pressure of about 23 bars. In the receiver 27 the temperature of the liquid Refrigerant-410 should be about −55° C., at pressure of 1 bar. Therefore, at the ambient temperature, for example −10° C., the low-boiling point working fluid in the heater 32 must be heated by 50° C., and in receiver 27 it should be cooled by 50° C.

In these conditions the device is started from an external power source, for example storage batteries. Power is supplied to electrical drivers of compressors of low pressure 1, average pressure 2 and high pressure 2, as well as to the pump 23 for circulating a heat-removing liquid and the pump 35 for circulating the refrigerant. The valves 13, 18, 22, 28 must be opened, and the valves 16, 17, 20, 29, 34 must be closed.

The low-boiling point working fluid is heated up in the heater 32 with the help of the heat-removing liquid which circulates by means of the pump 23 and takes away heat from the compressed atmospheric air (heat exchangers 7, 8, 9) and from the compressors of low, average and high pressure (1, 2, 3).

The low-boiling point working fluid is cooled in the refrigerator 26 with the help of the low-cooled atmospheric air after its expanding up to normal pressure into adjustable injector 19. This low-cooled air cools the liquid low-boiling point working fluid which circulates by means of pump 35 in a small circle: receiver 27-pump 35-heat exchanger 25-valve 28-refrigerator 26-receiver 27. After the temperature of the working fluid will reach the required level in the receiver 27 and in the heater 32, the valve 28 closes, and valves 20, 29 are opened.

Since in this embodiment, the piston engine is used as heat-engine 30, it starts up with the reversible generator 31. For this, the speed regulator of the heat-engine 30 is installed to the working mode and the reversible electric generator 31 is supplied with voltage storage batteries (on scheme is not showed). As a result, the heat-engine 30 starts to work. Then the generator 31 switches to the generation mode. From this point on, the device begins to produce the alternative green energy.

With the help of valves 13, 16, 17, 18, 22, 34, as well as the adjustable safety air valve 14 and adjustable injector 19 there are possible to regulate the temperature regime in the device for producing alternative energy in dependence on the load of electrical generator 31.

At ambient temperature +35° C.÷+45° C. the air compressors (compression stages 1, 2, 3) do not take part to start up to the device. The low-boiling point working fluid cools in the refrigerator 26 with the help of compressed atmospheric air from the cylinder 4, which is cooled to a low temperature during expanded in the injector 19. For this, the freon valves 20, 29 must be closed, and the valve 28 must be opened. The pump 35 for circulating the working fluid also runs into work from external source of power (storage batteries). The air valves 16, 17 must be closed, and valves 12, 13, 18 must be opened.

After the temperature of low-boiling point working fluid reaches about −55° C. in the receiver 27 the valves 20, 29 are opened, and valve 28 is closed. The shut-off valve 12 closes and the heat-engine 30 start working by supplying electric energy to the reversible generator 31 from an external power source (storage batteries). Then the generator 31 switches to the generation mode and the air compressors (compression stages 1, 2, 3) as well as pump 23 start working. The device is ready to producing electrical energy.

At ambient temperature −40° C.÷−50° C., the low-boiling point working fluid is heating up in the heater 32 with the help of heat from compressed atmospheric air and from the air compressors of low pressure 1, average pressure 2 and high pressure 3, which together with the pump 23 start working from an external source of power (storage batteries). Since there is no need to cool the working fluid in the receiver 27, the injector 19 must be closed, and compressed atmospheric air after the regenerative heat exchanger 11 is just released into the environment through the safety valve 14. The pump 35 must be turned on to regulate the level of liquid working fluid in the heater 32. The valve 28 must be closed.

After the temperature of the low-boiling point working fluid in the heater 32 will reach a predetermined value, the injector 19 opens and the heat-engine 30 starts up, as stated above. The device is ready to producing alternative electricity.

### Thermal Design

The amount of heat that is formed in the process of compression of atmospheric air can be calculated on the basis of data taken from the textbook “General Heat Engineering”, G. N. Alekseev, 1980, High School Moscow, § 73:
an energy intensity of 1 liter of kerosene is 37,000 kJ;
the amount of heat generated by burning 1 liter of kerosene in air compressed to 200 bars is 630 kJ;
density of kerosene is 0.78 kg/l;
density of air at T=+27° C. (300° K) is 1.17 kg/m³.

Since the combustion of 1 liter of kerosene in highly compressed air (200 bars) produces only 630 kJ of heat energy, therefore, most of this heat (36,370 kJ) is absorbed by the cooled air upon its expansion (37,000 kJ−630 kJ=36,370 kJ).

It is known that 15 kg of air requires for the complete combustion of 1 kg of liquid fuel, or about 10 m3 of atmospheric air is required to burn 1 liter of kerosene (15 kg/1.17 kg/m³=12.8 m³ and 12.8 m³×0.78=10 m³).

Based on the above calculation, it can be argued that when compressing 10 m3 of atmospheric air from 1 bar to 200 bars, about 36,370 kJ of heat one can be obtained, this is equivalent to 10 kWh of thermal energy (36,370 kJ/3600 kJ/kWh=10 kWh), or 1 m³ of atmospheric air during the process of its compression to 200 bars produces about 1 kWh of heat energy. Figures C, D and E visually illustrate the Thermal Design:

Fig. C shows the isothermal process of compressing air to 200 bars, with the dissipation of 36,370 kJ of heat energy into the environment.

Fig. D shows the process of burning kerosene (one liter) in the air compressed to 200 bars, with the supply of 36,370 kJ of heat energy from the environment.

Fig. E shows the adiabatic combustion process of kerosene (one liter) in the air compressed to 200 bars, with the supply 36,370 kJ of heat energy from its combustion.

Fig. F shows a graph the decrease of temperature during adiabatically expansion for two-atomic ideal gas.

The process of multi-stage compression of air with the removal of heat from each stage of the compressor is close to the isothermal process. Therefore, the energy costs for the operation of high-pressure compressor are minimal. The energy costs for compressor of high pressure to compress 10 m³ of atmospheric air from 1 bar to 200 bars (Tᵢₙᵢₜᵢₐₗ=T_{final}=300° K) is about 1.45 kWh (Barron R. F. Cryogenics Systems, Oxford University, Press 1985).

Moreover, the low-boiling point working fluid receives additional heat in the heat exchanger 11. Also, the residual heat energy, after heat-engine 30 and from the cooling of generator 31, returns to heater 32 thanks to the heat exchanger 25 at dividing of heat flows.

General Conclusions. Thus, the thermal design shows that the amount of heat energy obtained during the process of compression of atmospheric air to 200 bars exceeds the costs of energy for its compression by 6.5 times. Taking into account the heat extracted from the compressed air in regenerative heat exchanger 11, this value is increased to 10÷11. Practically all heat (except small losses) entering the heater 32 converts into mechanical energy in the heat-engine 30, due to the heat exchanger 25. If there are additional thermal sources or at a high positive ambient temperature (of water) the efficiency of the production of alternative green energy can be significantly increased at the same energy costs for the operation of air compressors (1, 2, 3), due to the constant inflow of cold into refrigerator 26.

Note. To heat 1 kg of oxygen from Tᵢ=30° K (−243° C.) to T_{f}=300° K (+27° C.), it is necessary to expend 7900 kJ (2.2 kWh) of heat. The coefficient of heat capacity of oxygen at T=30° K is about 29.3 kJ/kg*° K. In terms of 10 m3 of atmospheric air, it will be about 28 kWh of heat energy.

All this points to the huge amount of heat energy, which is contained air surrounding us, but it is not practically used for the production of cheap electricity.

Comparison of the values of the temperature of the heater (T₁) and the refrigerator (T₂) of the alternative energetics based on strong compression of atmospheric air with the temperature regime of real-life power plant to assess its efficiency on the Carnot cycle: {K_{ef}=1−(T₂/T₁)} (The Second Law of Thermodynamics).

The atmospheric air in the process of compression up to 200 bars is heated to 220° C. and heats the heat-removing liquid to T₁=80° C. (353° K), which in turn heats the refrigerant to a temperature of about 45° C. and a pressure of 25 bars. The temperature of the expanded air is T₂=−160° C. (113° K), that contributes to the condensation of the refrigerant. (K_{ef}=68%, T₁−T₂=240° C.). The efficiency 68% does not account the heat coming from regenerative heat exchanger 11 and the return of heat by means of heat exchanger 25.

The geothermal power plant is located on Kamchatka (Russia) with a capacity of 600 kW. The water from the well is fed to a heat-exchanger with temperature T₁=90° C. (363° K), where it heats Refrigerant-12 to a temperature of 65° C. and pressure of 13.9 bars. Condensation of exhaust Refrigerant-12 occurs in refrigerator, where temperature of cooling water is T₂=5° C. (278° K), at a pressure of 5 bars. (K_{ef}=23%, T₁−T₂=85° C.)

The sun power plant Solar One is located in the Mojave Desert (USA) with capacity of up to 275 megawatts. Concave mirrors heat the synthetic oil to T₁=390° C. (663° K), which heats the water and generates steam for the turbine. Condensation of exhaust steam takes place in a water cooling tower with T₂=50° C. (323° K). (K_{ef}=51%, T₁−T₂=340° C.)

The nuclear power plant has two water circuits. The water of the first circuit with T₁=320° C. (593° K) is fed to the steam generator of the second circuit, where it generates steam which rotates the turbogenerator. The temperature of the cooling water for condensation of exhaust steam is about T₂=20° C. (293° K). (K_{ef}=50%, T₁−T₂=300° C.)

Thus, one can see that Carnot cycle for energetics based on high compression of air is more effective than for other power plants because of the low-temperature refrigerator.

### Advantages

From the description above, a number of advantages of some embodiments of alternative energetics based on the extraction of internal energy from strong compressed air become evident:
(a) Obtaining electricity irrespective of weather conditions and seasonal cyclicality.
(b) No emissions of Carbon dioxide into the environment.
(c) Obtaining thermal energy for space heating and hot water supply at any time.
(d) Energy production in the form of compressed atmospheric air.
(e) Absence of large capacity batteries.
(f) Compactness and protection against impact of elements.
(g) Obtaining cold that has a special value in a hot climate.

### Conclusion, Ramifications, and Scope

Accordingly, the reader will see that the alternative energetics based on the extraction of internal energy in the process strong compression of atmospheric air of the various embodiments can be used in different fields of activity, from household use to various modes of transport, and it development will improve the climate change situation and it will help developing countries, in that:
it will allow more equitable distribution of electricity on the planet, as developing countries will have access to cheap energy;
cars, yachts, fishing vessels, light motor aircraft will not be tied to fuel stations;
the prices of food and seafood products will decrease, because the costs for their freezing and transportation will decrease;
the transition of auto transport to alternative energy will accelerate;
development of distribution electric power industry will be accelerated, and as a result, pollution of the environment from oil products will decrease and the emission of carbon dioxide into the atmosphere will decrease too;
the “oil and gas wars” will cease or, at least, greatly diminish.
   The use of the proposed alternative source together with thermal or nuclear power plants will significantly increase their effectiveness. Especially if those power plants are located in a hot climate, and next to them it is necessary to build fairly expensive hydraulic structures (cooling towers, ponds) to dissipate a large amount of heat, which is removed by cooling water during the condensation of water vapor. If this hot water to use to generate electricity, this will allow:
to produce electricity additionally;
to reduce the cost of building cooling towers and cooling ponds, while improving the conditions for cooling the power plants;
to use this alternative source of power as an independent power plant in case of emergency shutdown of nuclear power plant.

While the above description contains many specificities, these should not be construed as limiting the scope of the embodiment but as merely providing illustrations of some of several embodiments. Many other ramifications and variations are possible. For example, a turbine with more high or low pressure of low-boiling point working fluid can be used as a heat-engine. Air turbine or oil-free scroll compressors can be used as the air compressors of low and average pressures. Air expansion machine (detander) can be used as a drive for pump 35. Depending on climatic conditions as a low-boiling point working fluid there can be used substances such as Freon, Methane, Ethane, Propane, etc.

Thus the scope of the embodiment should be determined by the appended claims and their legal equivalents, rather by the examples given.

I claim:

1. A method to produce alternative energy based on a strong compression of atmospheric air to concentrate an internal thermal energy containing in said atmospheric air, comprising:
a) compressing and heating said atmospheric air in first air compressor of low pressure, wherein said low pressure is at least 6 bars;
b) removing heat from low compressed said atmospheric air, and cooling said first air compressor of low pressure using a heat-removing liquid;
c) removing a moisture condensate from said low compressed atmospheric air and discharging said moisture condensate to the environment;
d) compressing said low compressed atmospheric air in second air compressor of average pressure, wherein said average pressure is at least 36 bars;
e) removing heat from average compressed said atmospheric air, and cooling said second air compressor of average pressure using said heat-removing liquid;
f) compressing said average compressed atmospheric air in third air compressor of high pressure, wherein said high pressure is from 200 bars to 330 bars;
g) removing heat from high compressed said atmospheric air, and cooling said third air compressor of high pressure using said heat-removing liquid;
h) delivering cooled said high compressed atmospheric air to an oil-separator;
i) removing a lubricating oil from said cooled high compressed atmospheric air and delivering said lubricating oil into said third air compressor of high pressure;
j) delivering cleaned from said moisture condensate and from said lubricating oil said cooled high compressed atmospheric air to an injector;
k) expanding said cleaned cooled high compressed atmospheric air using said injector to a pressure of atmosphere, wherein expanded said atmospheric air cools to the temperature of low cold;
l) delivering said low cooled expanded atmospheric air to a refrigerator;
m) delivering heated said heat-removing liquid to a heater;
n) heating a liquid phase of a low-boiling point working fluid to a predetermined temperature in said heater using said heated heat-removing liquid to vaporize said liquid phase of said low-boiling point working fluid;
o) delivering said vaporized low-boiling point working fluid into a heat-engine to produce mechanical energy;
p) condensing said vaporized low-boiling point working fluid to said liquid phase using said low-cooled expanded atmospheric air in said refrigerator, and delivering said liquid phase of said low-boiling point working fluid to said heater for re-vaporizing, and dumping of utilized said expanded atmospheric air from said refrigerator to the environment,
and
q) controlling a heat exchange between said compressed atmospheric air, said heat-removing liquid and said low-boiling point working fluid using means for controllable heat exchanging,
whereby said alternative energy will be generated.

2. The method of claim 1 further including compressing said atmospheric air in said first air compressor of low pressure, wherein said first compressor is the oil-free air compressor.

3. The method of claim 1 further including pre-heating said liquid phase of said low-boiling point working fluid in a regenerative heat exchanger using said cooled high compressed atmospheric air.

4. The method of claim 1 further including using a heat exchanger for dividing the heat flows containing in said low-boiling point working fluid between said heater and said refrigerator.

5. The method of claim 1 further including maintaining a predetermined level of said liquid phase of said low-boiling point working fluid in said heater using a pump for circulation said low-boiling point working fluid.

6. The method of claim 1 further including using said utilized expanded atmospheric air for air conditioning of premises, for cooling foods and for getting distilled water.

7. The method of claim 1 further including diverting heat from said heated heat-removing liquid for hot water supply or premises heating using a heat-exchanger.

8. The method of claim 1 further including coupling said heat-engine to a generator for converting said mechanical energy to electricity.

9. The method of claim 1 further including pre-heating said liquid phase of said low-boiling point working fluid in a radiator heat-exchanger using heat of the environment or from thermal sources.

10. The method of claim 1 further including controlling said low pressure 6 bars using first air sensor in said first air compressor of low pressure.

11. The method of claim 1 further including controlling said average pressure 36 bars using second air sensor in said second air compressor of average pressure.

12. The method of claim 1 further including controlling said high pressure from 200 bars to 330 bars using third air sensor in said third air compressor of high pressure.

13. The method of claim 1 further including controlling total volume of said atmospheric air flowing into at least said first air compressor of low pressure depending on a load of said generator using said injector.

14. The method of claim 1 further including thermo-insulating at last said injector, said heater, said refrigerator, said receiver for said low-boiling point working fluid, said heat exchanger for dividing of heat flows, said regenerative heat exchanger and said pump for circulating of said low-boiling point working fluid.
